(19) United States
(12) Patent Application Publication
(10) Pub. No.: US 2006/0155838 A1
(43) Pub. Date: Jul. 13, 2006

(54) Program installation system and method using the same

(75) Inventors: Ming-Chen Wu, Taipei (TW); Lien-Hsun Chen, Taipei (TW); Tsung-Bin Wang, Taipei (TW); Tzu-Wen Chiu, Taipei (TW); Margaret Chen, Taipei (TW)

Correspondence Address: PEARL COHEN ZEDEK, LLP, 1500 BROADWAY 12TH FLOOR, NEW YORK, NY, 10036, US

(73) Assignee: INVENTEC CORPORATION

(21) Appl. No.: 11/092,727

(22) Filed: Mar. 30, 2005

(30) Foreign Application Priority Data
Dec. 31, 2004 (TW) 093141705

(51) Int. Cl. G06F 15/173

(52) U.S. Cl. 709/223

(57) ABSTRACT

A program installation system and method allowing a diskless computer device to perform program installation is proposed, the method comprising: establishing a booting unit and a memory section in the computer device, a DHCP server comprising a network information database for storing network setting information, and a storage server comprising a program storage section for storing at least one program and a information storage section for storing information sent from the network system; issuing a booting request by the booting unit; the DHCP server sending network setting information to the computer device in response to receiving the booting request; the computer device storing the network setting information in the memory section and issuing a program installation request based on the stored network setting information; the storage server storing information of the memory section in the information storage section and storing a network address of the storage server to the booting unit in response to receiving the program installation request; and the computer device being rebooted and connected to the storage server according to the stored network address, allowing the computer device to perform the program installation process by accessing the program storage section of the storage server.

### FIELD OF THE INVENTION

The present invention relates to program installation systems and methods using the same, and more particularly, to a program installation system for a diskless computer device and a method using the same

### DESCRIPTION OF THE PRIOR ART

Computer devices such as desktop computer or notebook computer usually have built-in Hard Disks (HDs). Operating system, applications, and package software can be installed in the hard disks to allow a computer system to successfully enter the operating system and perform subsequent user required operations after starting up.

However, the provision of hard disks increases hardware cost for developers of servers, such as blade servers. As shown in FIG. 1, a blade server 2 consists of a plurality of computer devices (2a, 2b, and 2c), each of them operates via the operating system, applications, and package software etc. stored in their respective hard disks 20. Thus, the number of hard disks fundamentally affects the cost of a blade server.

Currently, a solution is proposed by first installing an operating system to one of the computer devices of the blade server 2 using a hard disk, and then a configure image obtained after such installation is uploaded and stored in a server within a network system (the Internet or Intranet). After upload is completed, the hard disk is removed. However, this method still requires a hard disk to perform the operations of program installation. Moreover, if there are more than one computer devices, the single hard disk is plugged and unplugged into the various computer devices, causing great inconvenience in installing the programs.

Therefore, there is a need to provide a program installation system and method that easily allows a computer device to complete program installation with using a hard disk.

### SUMMARY OF THE INVENTION

In order to solve the problems of the prior art, a primary objective of the present invention is to provide a program installation system and method to enable a computer device with a hard disk to easily complete a program installation process.

In order to achieve the above objective, the present invention proposes a program installation system and method. The program installation system comprises a network system for transmitting data; at least one computer device connected to the network system having a booting unit and a memory section, the booting unit making a booting request when the computer device activating a booting process; a Dynamic Host Configuration Protocol (DHCP) server connected to the network system for providing DHCP services, the DHCP server comprising a network information database for storing network setting information, wherein when the DHCP server receives the booting request from the computer device, the DHCP server sends network setting information from the network information database to the computer device, which stores the network setting information sent by the DHCP server in the memory section, and the booting unit of the computer device sends a program installation request through the network system based on the network setting information stored in the memory section; and a storage server connected to the network system comprising a program storage section for storing at least one installation program and a information storage section for storing data sent from the network system and further supporting a Internet Small Computer System Interface (iSCSI) transmission protocol, the iSCSI transmission protocol of the storage server, in response to receiving the program installation request sent by the computer device, allowing information stored in the memory section of the computer device to be stored in the information storage section and further allowing a network address of the storage server to be stored in the booting unit, so that the booting unit connects to the storage server according to the stored network address when the computer device is rebooted and perform program installation process by accessing the program storage section of the storage server.

The program installation method for allowing a diskless computer device to perform booting and program installation processes via a network system and a remote server, the program installation method comprising the following steps of: establishing a booting unit and a memory section in the computer device; establishing a DHCP server for providing DHCP services and comprising a network information database for storing network setting information; establishing a storage server comprising a program storage section for storing at least one program and a information storage section for storing information sent from the network system and having a functionality of a iSCSI transmission protocol; issuing a booting request by the booting unit of the computer device; the DHCP server sending network setting information stored in the network information database to the computer device in response to receiving the booting request sent by the computer device; the computer device storing the network setting information sent from the DHCP server to the memory section and the booting unit of the computer device issuing a program installation request via the network system based on the network setting information stored in the memory section; the iSCSI transmission protocol of the storage server storing information stored in the memory section of the computer device in the information storage section and storing a network address of the storage server in the booting unit, in response to receiving the program installation request sent from the computer device; and the computer device being rebooted, and the booting unit connecting to the storage server according to the stored network address so as to allow the computer device to perform the program installation process by accessing the program storage section of the storage server.

### BRIEF DESCRIPTION OF THE DRAWINGS

A better understanding of the present invention can be obtained when the forgoing detailed description is considered in conjunction with the following drawings, in which:

FIG. 1 is a schematic diagram showing conventional computer devices performing program installation via their own hard disks;

FIG. 2 is a schematic block diagram showing a basic structure of a program installation system of the present invention; and

FIG. 3 is a flow diagram showing operating procedures for a program installation method of the present invention.

### DETAILED DESCRIPTION OF THE PREFFERED EMBODIMENT

The descriptions below of specific embodiments are to illustrate the present invention. Others skilled in the art can easily understand other advantages and features of the present invention from contents disclosed in this specification. The present invention can be carried out or applied through different embodiments. Every details of this specification can be modified based on different viewpoints and applications yet still within the scope of the present invention.

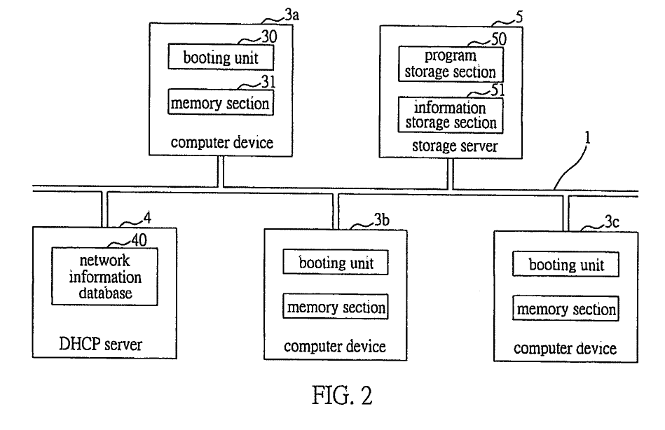

FIG. 2 shows a schematic block diagram showing a basic structure of the program installation system of the present invention. As shown, the program installation system comprises a network system 1, a plurality of computer devices (3a, 3b and 3c), a Dynamic Host Configuration Protocol (DHCP) server 4 and a storage server 5. The DHCP server 4 and the storage server 5 are both connected to the network system 1, which is an Internet or Intranet. It should be noted that, for simplicity and clarification, the basic structure illustrated herein only shows components related to the present invention. Other network apparatus, such as a gateway, a router or a switch that are irrelevant to the description of the present invention are omitted. Moreover, the number of computer devices is not limited to three, but can be any integer number depending on application. Hereinafter, only the computer device 3a is used to illustrate the following embodiment.

The computer device 3a can be for example a notebook computer, a desktop computer or a computer device within a blade server. The computer device 3a comprises a booting unit 30 and a memory section 31. The booting unit 30 is for example a Network Interface Card (NIC) that supports Proboot Execution Environment (PEX) and stores a Media Access Control (MAC) address. The memory section 31 is a memory storage segmented from a built-in memory of the computer device 3a, and it can be, for example, a flash ROM, a PROM, an EPROM or an EEPROM, for use as a temporary virtual disk.

The DHCP server 4 provides DHCP services and includes a network information database 40 for storing network setting information. The network setting information include information related to IP address, network mask, gateway, Domain Name System (DNS) server etc. Since the aforementioned DHCP and MAC are well known techniques to those with ordinary skill in the art of network technology, thus operating functionality and internal structures thereof will not be further described.

Since the computer device 3a do not include a hard disk itself, so when booting of the computer device 3a is activated, the booting unit 30 activates the PXE interface to request required booting services from a remote server, that is, the booting unit 30 automatically connects to the DHCP server 4 in the network system 1 and sends the MAC information thereto. Upon receiving the MAC information sent by the computer device 3a, network setting information accessed from the network information database 40 of the DHCP 4 is then sent back to the computer device 3a by the DHCP server 4. The computer device 3a temporarily stores the network setting information in its memory section 31.

The storage server 5 comprises a program storage section 50 for storing at least a installation program and a information storage section 51 for storing information sent from the network system 1. The storage server 5 supports an iSCSI (Internet Small Computer System Interface) transmission protocol. After the computer device 3a temporarily storing the network setting information in the memory section 31, the booting unit 30 connects to the storage server 5 according to the stored network setting information and makes a program installation request. Thereupon, the storage server 5 stores information from the memory section 31 of the computer device 3a into the information storage section 51 via the network system 1. The stored information additionally includes the MAC information of the computer device 3a for identification by the storage server 5.

After information is stored from the memory section 31 of the computer device 3a into the information storage section 51 of the storage server 5, the computer device 3a is then able to access the programs stored in the program storage section 50, wherein the program storage section 50 comprises operating system, application and package software etc. When the computer device 3a installs the operating system, the storage server 5 stores a configuration file established during the installation process of the operating system into the information storage section 51. The configuration file additionally includes the MAC information for identification by the storage server 5.

The first time a connection is established between the computer device 3a and the storage server 5 via the network system 1, the storage serer 5 also stores its IP address in the booting unit 3 of the computer device 3a, so that next time the computer device 3a is booted, it can reconnected with the storage server 5 via the network system 1 based on the stored IP address. The information storage section 51 of the storage server 5 also stores the MAC related information of the computer device 3a for determining whether the computer device 3a is allowed to proceed with operations of data or program access.

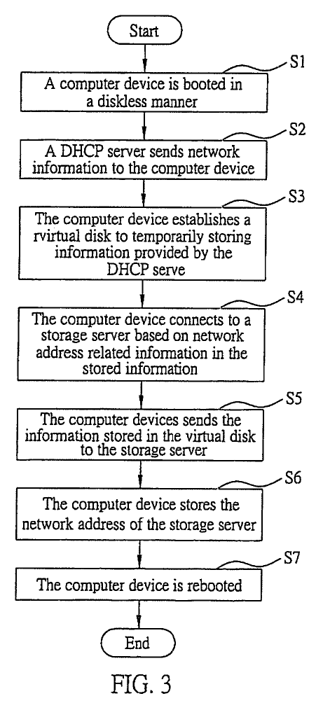

FIG. 3 shows a flow diagram of operating procedures for the program installation method of the present invention. Assuming that the computer device 3a of this embodiment performs booting for the first time. As shown, in step S1, the computer device 3a performs a diskless booting, that is, the computer 3a makes the booting unit 30 activate the PXE interface in order to request the remote server for required booting services and send the MAC information, then moving to step S2.

In step S2, upon receiving the MAC information sent by the computer device 3a, network setting information accessed from the network information database 40 of the DHCP server 4 is then sent back to the computer device 3a via the network system 1. Then, moving to step S3.

In step S3, the computer device 3a forms a storage section 31 segmented from a built-in memory of the computer device 3a, i.e. forming a virtual disk in order to temporarily store the network setting information sent from the DHCP server 4 in the storage section 31. Then, performing step S4.

In step S4, the computer device 3a connects to the storage server 5 according to the network setting information stored in the memory section 31. Then, peforming step S5.

In step S5, upon connecting to the storage server 5 according to the network setting information stored in the memory section 31 (virtual disk), the computer device 3a then makes a program installation request. Based on the program installation request sent by the computer device 3a, the storage server 5 stores information from the memory section 31 of the computer device 3a into the information storage section 51 via the network system 1. The stored information additionally includes the MAC information of the computer device 3a for identification by the storage server 5. Then, moving to step S6.

In step S6, the booting unit 30 of the computer device 3a stores the network address of the storage server 5 to be used as a network connection reference for booting next time. Then, moving to step S7.

In step S7, the computer device 3a is rebooted. The booting unit 30 of the computer device 3a establishes a network connection with the storage server 5 based on the stored network address of the storage server 5. The computer device 3a then performs program access and installation based on the information stored in the program storage section 50 of the storage server 5; the configuration file generated by the computer device 3a during the installation process is stored in the information storage section 51 by the storage server 5 for use as a reference to determine whether to allow the computer device 3a to perform program installation the next time it is booted.

After information is stored from the memory section 31 of the computer device 3a into the information storage section 51 of the storage server 5, the computer device 3a is then able to access the programs stored in the program storage section 50, wherein the program storage section 50 comprises operating system, application and package software etc. When the computer device 3a installs the operating system, the storage server 5 stores a configuration file established during the installation process of the operating system into the information storage section 51. The configuration file additionally includes the MAC information for identification by the storage server 5.

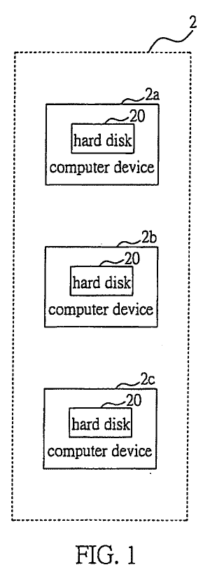

Therefore, a diskless computer device is able to perform processes such as booting, program installation and data accessing through the use of the program installation system and method of the present invention. In contrast to the computer device of the prior art shown in FIG. 1, the program installation system and method achieves fast and convenient program installation for a plurality of diskless computer devices by only employing the existing network system, a DHCP server having the functionality of network address configuration and a storage server having large capacity and fast processing performance.

The embodiments described above are only to illustrate aspects of the present invention; it should not be construed as to limit the scope of the present invention in any way.

While the invention has been described in detail with reference to specific embodiments thereof, it will be apparent in the art that various changes and modifications can be made, and equivalents employed, without departing from the scope of the claims.

What is claimed is:

1. A program installation system, comprising:
a network system for transmitting data;
at least one computer device connected to the network system having a booting unit and a memory section, the booting unit making a booting request when the computer device activating a booting process;
a Dynamic Host Configuration Protocol (DHCP) server connected to the network system for providing DHCP services, the DHCP server comprising a network information database for storing network setting information, wherein when the DHCP server receives the booting request from the computer device, the DHCP server sends network setting information from the network information database to the computer device, which stores the network setting information sent by the DHCP server in the memory section, and the booting unit of the computer device sends a program installation request through the network system based on the network setting information stored in the memory section; and
a storage server connected to the network system comprising a program storage section for storing at least one installation program and a information storage section for storing data sent from the network system and further supporting a Internet Small Computer System Interface (iSCSI) transmission protocol, the iSCSI transmission protocol of the storage server, in response to receiving the program installation request sent by the computer device, allowing information stored in the memory section of the computer device to be stored in the information storage section and further allowing a network address of the storage server to be stored in the booting unit, so that the booting unit connects to the storage server according to the stored network address when the computer device is rebooted and perform program installation process by accessing the program storage section of the storage server.

2. The program installation system as claimed in claim 1, wherein the booting unit has a Proboot Execution Environment (PEX) interface and is constructed on a Network Interface Card (NIC) for enabling the computer device to perform the program installation process using the remote storage server via the network system.

3. The program installation system as claimed in claim 1, wherein the booting unit stores a Media Access Control (MAC) address, such that when the storage server storing information of the memory section of the computer device in the information storage section, the MAC address of the computer device is also stored therein.

4. The program installation system as claimed in claim 1, wherein the booting unit stores a Media Access Control (MAC) address, such that when the computer device installs the program stored in the program storage section of the storage server and generates the corresponding configuration file which further comprises the MAC address that is stored in the information storage section of the storage server.

5. The program installation system as claimed in claim 1, wherein the memory unit is a storage space segmented from a memory of the computer device.

6. The program installation system as claimed in claim 5, wherein the memory is a built-in memory of the computer device selected from the group consisting of a flash Read-Only Memory (ROM), a Programmable Read-Only Memory (PROM), an Erasable Programmable Read-Only Memory (EPROM) and an Electrically Erasable Programmable Read-Only Memory (EEPROM).

7. The program installation system as claimed in claim 1, wherein the network setting information is at least one information selected from the group consisting of an IP address, a network mask, a gateway information, and a Domain Name System server information.

8. A program installation method for allowing a diskless computer device to perform booting and program installation processes via a network system and a remote server, the program installation method comprising the following steps of:
establishing a booting unit and a memory section in the computer device;
establishing a DHCP server for providing DHCP services and comprising a network information database for storing network setting information;
establishing a storage server comprising a program storage section for storing at least one program and a information storage section for storing information sent from the network system and having a functionality of a iSCSI transmission protocol;
issuing a booting request by the booting unit of the computer device;
the DHCP server sending network setting information stored in the network information database to the computer device in response to receiving the booting request sent by the computer device;
the computer device storing the network setting information sent from the DHCP server to the memory section and the booting unit of the computer device issuing a program installation request via the network system based on the network setting information stored in the memory section;
the iSCSI transmission protocol of the storage server storing information stored in the memory section of the computer device in the information storage section and storing a network address of the storage server in the booting unit, in response to receiving the program installation request sent from the computer device; and
the computer device being rebooted, and the booting unit connecting to the storage server according to the stored network address so as to allow the computer device to perform the program installation process by accessing the program storage section of the storage server.

9. The program installation method as claimed in claim 8, wherein the booting unit has a Proboot Execution Environment (PEX) interface and is constructed on a Network Interface Card (NIC) for enabling the computer device to perform the program installation process using the remote storage server via the network system.

10. The program installation method as claimed in claim 8, wherein the booting unit stores a Media Access Control (MAC) address, such that when the storage server storing information of the memory section of the computer device in the information storage section, the MAC address of the computer device is also stored therein.

11. The program installation method as claimed in claim 8, wherein the booting unit stores a Media Access Control (MAC) address, such that when the computer device installs the program stored in the program storage section of the storage server and generates the corresponding configuration file which further comprises the MAC address that is stored in the information storage section of the storage server.

12. The program installation method as claimed in claim 8, wherein the memory unit is a storage space segmented from a memory of the computer device.

13. The program installation method as claimed in claim 12, wherein the memory is a built-in memory of the computer device selected from the group consisting of a flash Read-Only Memory (ROM), a Programmable Read-Only Memory (PROM), an Erasable Programmable Read-Only Memory (EPROM) and an Electrically Erasable Programmable Read-Only Memory (EEPROM).

14. The program installation method as claimed in claim 8, wherein the network setting information is at least one information selected from the group consisting of an IP address, a network mask, a gateway information, and a Domain Name System server information.
